(19) United States
(12) Patent Application Publication
(10) Pub. No.: US 2014/0179840 A1
(43) Pub. Date: Jun. 26, 2014

(54) Low Emission, UV Stabilized High Strength Acetal Copolymer

(71) Applicant: Ticona LLC, Florence, KY (US)

(72) Inventors: Mark Tyler, New Richmond, OH (US); Bruce M. Mulholland, Hebron, KY (US)

(73) Assignee: Ticona LLC, Florence, KY (US)

(21) Appl. No.: 14/137,025

(22) Filed: Dec. 20, 2013

Related U.S. Application Data
(60) Provisional application No. 61/746,008, filed on Dec. 26, 2012.

(51) Int. Cl. C08K 13/02; C08K 5/17; C08K 5/3415

(52) U.S. Cl. CPC C08K 13/02; C08K 5/3415; C08K 5/175
USPC 524/94; 524/106

(57) ABSTRACT

Polymer compositions and molded articles made from the polymer compositions are described which contain a high strength polyoxymethylene polymer, an emission control agent, and at least one light stabilizer. The polymer composition not only has excellent resistance to ultraviolet light but also exhibits low formaldehyde emission. In one embodiment, the emission control agent comprises allantoin while the light stabilizer comprises a hindered amine.

### RELATED APPLICATIONS

The present application claims priority to U.S. Provisional Patent Application Ser. No. 61/746,008, filed on Dec. 26, 2012, which is incorporated herein in its entirety by reference thereto.

### BACKGROUND

Polyacetal polymers, which are commonly referred to as polyoxymethylenes (POMs), have become established as exceptionally useful engineering materials in a variety of applications, POMs for instance, are widely used in constructing molded parts, such as parts for use in the automotive industry and the electrical industry. POMs, for instance, have excellent mechanical property, fatigue resistance, abrasion resistance, chemical resistance, and moldability.

Although polyacetal resins possess many useful properties, the polymers have a tendency to degrade when heated and are inherently unstable in an oxidative atmosphere or in an acidic or alkaline environment. In particular, polyacetal resins, especially higher strength grades, have a tendency to emit formaldehyde during processing and after the polymer has been molded into a part. Formaldehyde is not only a contaminant, but can also adversely affect metallic components that may be placed in association with the polymer. For example, formaldehyde readily oxidizes to formic acid which can corrode metals or cause discoloration.

In view of the above, those skilled in the art have attempted to combine polyacetal polymers with various compounds in order to lower formaldehyde emissions. For instance, in the past, polyacetal polymers have been combined with melamines, benzoguanamines or hydrazines in order to achieve lower formaldehyde emission performance.

Another problem that has been encountered in the use of polyacetal polymers is that under some applications, the polyacetal polymers have a tendency to degrade and discolor when exposed to ultraviolet light. For instance, ultraviolet light resistance has been a problem for molded products containing a polyacetal polymer that are used on the interior of automobiles. Such molded parts can include trim pieces, visor clips, trim bezels, handles, air bag covers, and the like. Various pigments and dyes are typically blended with the polyacetal polymer in order to match or coordinate with other colors present in the environment in which the parts are used. Interior automotive parts are subjected to ultraviolet light cycles and thermal cycles during use which have a tendency to cause fading. Thus, in the past, various different light stabilizers have been proposed for use in combination with polyacetal polymers.

Unfortunately, however, when additives are combined with a polyacetal polymer in order to enhance one property, the additive may have an adverse impact on another property. For example, adding light stabilizers to polyacetal polymers may lead to increased formaldehyde emissions even when the polymer composition contains a formaldehyde scavenger.

The above problems can even be more pronounced when the polyacetal polymer comprises a homopolymer or comprises a copolymer with low amounts of comonomers units. Such polyacetal polymers, for instance, can have relatively high strength and relatively low melt flow rates.

In view of the above, a need currently exists for a high strength polymer composition containing a polyacetal polymer that is not only ultraviolet light resistant, but also exhibits low formaldehyde emission.

### SUMMARY

In general, the present disclosure is directed to a polymer composition containing primarily a polyacetal resin and to molded products made from the composition. The polymer composition of the present disclosure is particularly formulated so as to not only be ultraviolet light resistant, but also to exhibit low formaldehyde emissions.

In one embodiment, the present disclosure is directed to a molded product made from a polymer composition that has resistance to ultraviolet light and exhibits low formaldehyde emission. The polymer composition comprises a polyoxymethylene polymer combined with an emission control agent and at least one light stabilizer.

In accordance with the present disclosure, the polyoxymethylene polymer comprises an oxymethylene copolymer having relatively low amounts of comonomers units. The copolymer may include oxymethylene units and oxyalkylene units having at least two carbon atoms and a proportion of terminal alkyl ether groups and of terminal hydroxyalkylene groups having at least two carbon atoms. The proportion of terminal alkyl ether groups present in the copolymer, based on all terminal groups, can be at least about 80% and the proportion of terminal hydroxyalkylene groups having at least two carbon atoms, based on all the terminal groups can be up to about 20%. In one embodiment, for instance, at least about 90% of all terminal groups are terminal alkyl ether groups, such as terminal ethyl ether or methyl ether groups.

In one particular embodiment, the oxymethylene copolymer has the following formula:

—(O—CH₂)ₓ—(O—CₘH₂ₘ)_{y}—

and has terminal alkyl ether groups of the formula —O—R¹ and terminal hydroxyalkylene groups of the formula —O—CₘH₂ₘ—OH and, if appropriate, terminal groups of the formula —O—R², and wherein:
x is a positive integer, preferably from 10 to 10 000,
m is an integer from 2 to 6,
y is an integer from 0 to 10,
the ratio yₐᵣ/xₐᵣ is from 0.001 to 0.7
yₐᵣ being the arithmetic mean of all values y in the polymer mixture and
xₐᵣ being the arithmetic mean of all values x in the polymer mixture,
R¹ is a linear or branched alkyl group and

R² is a formyl group —CHO, with the proviso that the proportion of the terminal alkyl ether groups of the formula —O—R¹, based on all terminal groups, is at least 80%, and that the proportion of the terminal hydroxyalkylene groups of the formula —O—CₘH₂ₘ—OH, based on all terminal groups, is up to 20%. In one embodiment, the index x above is an integer from about 300 to about 10,000.

As described above, the oxymethylene copolymer is combined with an emission control agent and at least one light stabilizer. In accordance with the present disclosure, the emission control agent comprises allantoin. The allantoin can be present in the polymer composition in an amount from about 0.01% to about 5% by weight, such as from about 0.01% to about 2% by weight, such as from about 0.01% to about 1% by weight.

The at least one light stabilizer present in the polymer composition may comprise a hindered amine. In one embodiment, a hindered amine is selected that has a pH of from about 6 to about 8. As used herein, the pH is determined after the compound is placed in distilled water. In one embodiment, for example, the hindered amine may comprise an oligomeric N-methylated hindered amine light stabilizer, such as 1,2,3,4-butanetetracarboxylic acid. The light stabilizer may be present in the composition in an amount from about 0.1% to about 2% by weight, such as in an amount from about 0.1% to about 1% by weight.

The polymer compositions in accordance with the present disclosure may exhibit a formaldehyde emission of less than about 15 ppm, such as less than about 10 ppm, such as less than about 8 ppm. Formaldehyde emission is measured according to VDA 275 (German Automotive Industry Recommendation No. 275) as documented by Kraftfahrwesen e. V., July 1994.

In addition to having low formaldehyde emission, the polymer composition may also be ultraviolet light resistant. For instance, the polymer composition can be formulated so as to exhibit a color difference value (DEcmc) of less than about 5, such as less than about 3, such as less than about 2, such as even less than about 1 after exposure to ten cycles with 2800 kJ/m² irradiation in a xenon arc weatherometer operated according to Volkswagen Test PV1303.

The polymer composition can exhibit the above color difference values even when containing a coloring agent that produces a relatively dark color. The coloring agent, for instance, may comprise one or more pigments and/or one or more dyes that results in a molded article having a gray color, a green color, a brown color or a black color.

Other features and aspects of the present disclosure are discussed in greater detail below.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a high strength polymer composition containing a polyacetal resin, particularly a polyoxymethylene copolymer, that is ultraviolet light resistant and exhibits low formaldehyde emissions. The polymer composition is well suited for use in molding processes for producing molded articles. The polymer composition can contain one or more coloring agents for producing molded articles having any desired color. The molded articles can be used in a limitless variety of different applications and in multiple fields. In one embodiment, for instance, molded articles may be made according to the present disclosure that are designed to function as automotive parts, such as automotive parts designed to be used in the interior of vehicles, such as cars and trucks.

More particularly, the present disclosure is directed to a polymer composition containing a polyacetal resin in combination with an emission control agent that controls formaldehyde emissions and at least one light stabilizer. In one embodiment, the polyacetal resin comprises an oxymethylene copolymer. The oxymethylene copolymer has high strength characteristics and includes terminal alkyl ether groups and terminal hydroxyalkylene groups such that the terminal alkyl ether groups comprise at least about 80% of all the terminal groups of the copolymer and the terminal hydroxyalkylene groups comprise less than about 20% of all the terminal groups.

The above oxymethylene copolymer is combined with an emission control agent that comprises allantoin. The at least one light stabilizer present in the polymer composition may comprise a hindered amine. In one embodiment, the hindered amine has a substantially neutral pH. The hindered amine, for instance, can have a pH of from about 5 to about 9, such as from about 6 to about 8.

The emission control agent and the at least one light stabilizer are combined with the oxymethylene copolymer in a manner such that the resulting polymer composition exhibits low formaldehyde emission in combination with high ultraviolet light stability. In this manner, when molded articles are produced from the polymer composition and used in an environment subjected to intense amounts of sunlight and thermal cycles, the molded article not only displays color fastness characteristics, but also emits relatively low amounts of formaldehyde.

For instance, in one embodiment, the polymer composition containing the polyoxymethylene polymer exhibits a formaldehyde emission pursuant to VDA 275 of less than about 15 ppm, such as less than about 10 ppm, such as less than about 8 ppm. The formaldehyde emission of the polymer composition may be substantially zero and, in some embodiments, greater than about 1 ppm.

In addition to exhibiting low formaldehyde emissions, molded articles made according to the present disclosure can withstand ultraviolet light without significant discoloration. In this regard, the polymer composition can contain one or more coloring agents for producing molded articles having a distinct color that does not significantly fade even when subjected to multiple doses of ultraviolet light.

For instance, various tests exist that are referred to as hot lightfastness tests in which a molded article is subjected to ultraviolet light produced by a xenon arc lamp. In some tests, during exposure to ultraviolet light, the molded articles are also subjected to heat. One test, for instance, that has been used in the past is SAE (Society of Automotive Engineers) Standard J1885. SAE Standard J1885, for instance, is described in U.S. Pat. No. 4,996,253, which is incorporated herein by reference.

Another test that was developed for investigating lightfastness of interior automotive parts is Volkswagen Test PV 1303 (2001-03). Test PV 1303 is based on ISO Test 105-B06 and Test VDA 75202. According to Test PV 1303, a specimen is subjected to continuous light emitted by a xenon arc lamp using window glass as a filter system. The test uses the following parameters:

| UV cut-on | 320 nm |
|---|---|
| E in W/m² (300-400 nm) | 60 |
| E in W/m² nm at 420 nm | 1.2 |
| BST in ° C. (light) | 100 |
| CHT in ° C. (light) | 65 |
| RH in % (light) | 20 |

Volkswagen Test PV 1303 is intended to be applied to non-metal materials intended for use in vehicle interiors.

When subjecting specimens to Volkswagen Test PV 1303, the specimen can be exposed to one or more cycles of exposure to ultraviolet light. In one embodiment, for instance, the specimen can be subjected to ten cycles (10 cycles is 2800 kJ/m², i.e. each cycle is 280 kJ/m²).

After being subjected to the above tests, the color difference of the specimen can be measured. For instance, color difference values (DE) can be based on the L*C*h* color scale, which takes into account differences in lightness, chroma and hue. One metric for color difference values can be “cmc”. Color measurement is performed using a DataColor 600 Spectrophotometer utilizing an integrating sphere with measurements made using the specular included mode. Color coordinates are calculated according to ASTM D2244-11 under illuminant D65, 10° observer, using CIELab units. A further modification of CIELab units can be performed according to AATCC Test Method 173-1992 whereby a total color difference is calculated using the CMC equation (DEcmc). This color difference scale has shown better correlation to visual assessment compared to CIELab or HunterLAB equations. Using the CMC equation, a lightness to chroma ratio (l:c ratio) of 1.3:1 is used.

As described above, polymer compositions made according to the present disclosure are very stable even when exposed to relatively high amounts of ultraviolet light. In this regard, molded articles made from the polymer composition can, in one embodiment, include a coloring agent in an amount sufficient for the polymer article to display a desired color. Of particular advantage, polymer compositions made according to the present disclosure can exhibit a color difference value (DEcmc) of less than about 5, such as less than about 2, such as even less than about 1 when exposed to ten cycles of 280 kJ/m² irradiation emitted by a xenon arc weatherometer operated according to VW Test PV 1303.

Polymer compositions made according to the present disclosure include a polymer matrix that is primarily comprised of a polyacetal resin, which is also commonly referred to as a polyoxymethylene polymer. The heat deflection temperature or heat distortion temperature, as used herein, is determined at 1.8 MPa and is recorded in °C. The heat deflection temperature is typically abbreviated in DTUL or HDT and is tested according to ISO Test 75 Method A. Polymer compositions according to the present disclosure, for instance, can have an HDT of greater than about 165° C. such as greater than about 170° C., such as greater than about 175° C., such as greater than about 180° C. The HDT is generally less than about 210° C.

In accordance with the present disclosure, the polyoxymethylene polymer, comprises a polyoxymethylene copolymer with relatively low comonomer content. The polyoxymethylene polymer, for instance, can primarily contain oxymethylene units with a relatively low proportion of comonomer units. For instance, the comonomer units can be from about 0.001% to about 1% by weight. The comonomer units, for instance, may comprise oxyalkylene units such as oxyethylene units. The polyoxymethylene copolymer can be produced by cationic polymerization of trioxane with low amounts of a comonomer, such as dioxolane. In one embodiment, the polyoxymethylene copolymer can include terminal methoxy units. In one embodiment, the polyoxymethylene copolymer may also include terminal hydroxyl groups.

In one embodiment, an oxymethylene copolymer is used that comprises oxymethylene units and oxyalkylene units having at least two carbon atoms and a proportion of terminal alkyl ether groups and of terminal hydroxyalkylene groups having at least two carbon atoms. The proportion of terminal alkyl ether groups, in one embodiment, can be at least about 80%, while the proportion of terminal hydroxyalkylene groups can be less than about 20%.

Preferred oxymethylene copolymers comprise a proportion of oxyalkylene units having at least two carbon atoms, based on the proportion of the oxymethylene units, of between 0.001% and 1%, such as between 0.01% and 0.5% by weight.

The oxymethylene copolymers can furthermore be distinguished in one embodiment by zero or a very low content of terminal formyl groups. This is typically from 0.01 to 2% of all terminal groups. Oxymethylene copolymers having a content of terminal formyl groups of less than 1% of all terminal groups are preferred. In addition, other conventional terminal groups, for example terminal hemiacetal groups, may still, if appropriate, be present in very small amounts, for example in amounts of less than 11%.

The oxymethylene copolymers can comprise a polymer of the formula I:

—(O—CH₂)ₓ—(O—CₘH₂ₘ)_{y}— (I)

which have terminal alkyl ether groups of the formula —O—R¹ and terminal hydroxyalkylene groups of the formula —O—CₘH₂ₘ—OH and, if appropriate, terminal groups of the formula —O—R², in which
x is a positive integer, preferably from 10 to 10 000, such as from 300 and 10 000,
m is an integer from 2 to 6, preferably 2,
y is an integer from 0 to 10,
the ratio yₐᵣ/xₐᵣ is from 0.001 to 0.7
yₐᵣ being the arithmetic mean of all values y in the polymer mixture and
xₐᵣ being the arithmetic mean of all values x in the polymer mixture,
R¹ is a linear or branched alkyl group and

In one embodiment, R² is a formyl group —CHO, with the proviso that the proportion of terminal alkyl ether groups of the formula —O—R¹, based on all terminal groups, is at least 80%, and that the proportion of terminal hydroxyalkylene groups of the formula —O—CₘH₂ₘ—OH, based on all terminal groups, is up to 20%.

In one embodiment, yₐᵣ is the arithmetic mean of all values y in the polymer mixture and xₐᵣ is the arithmetic mean of all values x in the polymer mixture.

The mean value xₐᵣ can be from 50 to 5000.

R¹ and R² can be C₁-C₆-alkyl radicals, which may be straight-chain.

R¹ and R², independently of one another, can be methyl or ethyl, in particular methyl.

The oxymethylene polymers described above can be formed from a process which comprises:

a) polymerization of least one monomer forming —CH₂—O— units and at least one monomer forming oxyalkylene units having at least two carbon atoms, in the presence of at least one acetal of formaldehyde, with at least one protic acid or one of its derivatives as an initiator, the concentration of the initiator being less than 10⁻⁴ mol %, based on the amount of monomers which are present at the beginning of the polymerization and form —CH₂—O— units,
b) use of starting materials of the polymerization such that the content of water and formic acid at the beginning of the polymerization is less than or equal to 40 ppm, and
c) deactivation of the initiator and/or of the active polymer chains by treatment of the prepared polymer with basic compounds in a protic solvent.
Step a) of the process is a polymerization of monomers forming —CH₂—O— units with at least one monomer forming oxyalkylene units having at least two carbon atoms and optionally further comonomers and/or branching agents. The polymerization can be effected homogeneously or preferably heterogeneously.

A monomer forming —CH₂—O— units and a monomer forming oxyalkylene units having at least two carbon atoms or a mixture of different monomers is reacted in a manner with protic acids as an initiator of the cationic polymerization and with acetals of formaldehyde as regulator. The polymerization can be effected at atmospheric pressure or at moderate pressures up to 25 bar, for example at pressures of from 1 to 10 bar.

The polymerization temperature can be below the melting point of the resulting polymer.

Typical polymerization temperatures are in the range from 60 to 160° C., such as from 70 to 140° C.

The molecular weights, characterized as melt volume flow rate MVR, of these polymers can be adjusted within wide ranges. Typical MVR values are from 0.1 to 100 g/10 min, such as from 1 to 80 g/10 min, measured according to EN ISO 1133 at 190° C. at a load of 2.16 kg. In one embodiment, a polyoxymethylene polymer may be used in the composition that has a relative low melt volume flow rate, such as less than about 4 g/10 min., such as from about 1 g/10 min to about 4 g/10 min. In an alternative embodiment, however, a polyoxymethylene polymer may be selected that has a higher melt volume flow rate. For instance, the melt volume flow rate of the polymer can be greater than about 5 g/10 min, such as greater than about 6 g/10 min, such as greater than about 7 g/10 min. In one embodiment, for instance, the melt volume flow rate can be from about 5 g/10 min to about 12 g/10 min.

If desired, small amounts of branching agents may be used. Usually, the amount of branching agents is not more than 1% by weight, based on the total amount of monomers which is used for the preparation of the oxymethylene polymers, preferably not more than 0.3% by weight. Preferred branching agents are polyfunctional epoxides, glycidyl ethers or cyclic formals.

In one embodiment at a chain transfer agent (regulator) comprises compounds of the formula II

R³—(O—CH₂)_{q}—O—R⁴ (II)

in which R³ and R⁴, independently of one another, are linear or branched alkyl radicals, in particular C₁-C₆-alkyl radicals, which can be straight-chain.

R³ and R⁴, independently of one another, can be methyl, ethyl, propyl or butyl.

In one embodiment, the chain transfer agents are compounds of the formula II in which q is 1 or methyial.

The chain transfer agents are usually used in amounts of up to 20 000 ppm, preferably from 100 to 5000 ppm, such as from 200 to 2000 ppm, based on the monomer mixture.

In an alternative embodiment, a glycol such as ethylene glycol may be used as a molecular weight regulator. When ethylene glycol is used as a regulator, greater amounts of terminal hydroxy groups may be created on the polymer chains.

Suitable initiators are in particular strong protic acids, such as fluorinated or chlorinated alkane- and arylsulfonic acids, e.g. trifluoromethanesulfonic acid, or derivatives thereof, such as esters or anhydrides of protic acids, in particular trifluoromethanesulfonic anhydride or trifluoromethanesulfonic esters, such as the alkyl esters. Also suitable are perchloric acid and esters thereof and protic acids in the presence of salts thereof.

Initiators are those compounds which, in concentrations of <10⁻⁴ mol %, initiate the polymerization.

The initiators are used in very small amounts. In the process, initiators are used in an amount of less than or equal to 10⁻⁴ mol %, preferably from 10⁻⁶ mol % to 10⁻⁴ mol %, based on the amount of the monomers which are present at the beginning of the polymerization and form —CH₂—O— units.

In the process according to the invention, purified starting materials are used in the polymerization, such that the content of water and formic acid during the polymerization is less than 100 ppm, such as less than 40 ppm, based on the amount of monomers present at the beginning of the polymerization and forming —CH₂—O— units. The determination of the water and formic acid content in the monomers is effected by the conventional methods, i.e. water by Karl Fischer and formic acid by acid-based titration.

After polymerization, the solid or liquid polymerization mixture is dissolved according to point c) using a protic solvent which contains at least one base. As a result, the initiator and active polymer chains are deactivated. A thermal, controlled degradation of the unstable terminal groups takes place.

The dissolution is typically effected at temperatures from 130 to 200° C., such as from 140 to 190° C.

All of these compounds which are capable of ending a cationic polymerization, for example compounds which undergo a basic reaction with water, can be used as the base. Bases which do not react with formaldehyde are preferred. Examples are tertiary amines, such as triethylamine, or secondary alkali metal phosphates, such as disodium hydrogen phosphate, or amides, such as dimethylformamide or dimethylacetamide, or aromatic amines, such as melamine.

Typical deactivation pressures are in the range from 1 to 50 bar, preferably from 2 to 30 bar, in particular from 3 to 20 bar.

The duration of the thermal treatment is from 10 seconds to 2 hours, preferably from 1 minute to 60 minutes, depending on the temperature. The treatment can be effected with substantial exclusion of oxygen.

The protic solvent used can be a mixture which contains water and methanol. The water concentration is from 2% by weight to 50% by weight, such as from 5% by weight to 30% by weight. The methanol concentration is from 50 to 90% by weight, such as from 70% by weight to 90% by weight,

After the deactivation and degradation of the unstable fractions in the above-described protic solvent which has been made basic, the polymer is precipitated. The precipitation can be effected, for example, by cooling the solution. The precipitation is followed by drying of the polymer. Mechanical and/or thermal methods can be used for drying.

The polyoxymethylene polymer is present in the polymer composition generally in an amount greater than about 40% by weight, such as in an amount greater than 50% by weight, such as in an amount greater than 60% by weight. In certain embodiments, for instance, the polymer composition may contain the polyoxymethylene polymer in amounts greater than about 70% by weight, such as in amounts greater than about 80% by weight, such as even in amounts greater than about 90% by weight. In general, the polyoxymethylene polymer is present in the polymer composition in an amount less than about 98% by weight, such as in an amount less than about 95% by weight.

The polyoxymethylene polymer as described above is combined with an emission control agent and at least one light stabilizer in accordance with the present disclosure. The emission control agent comprises allantoin. Allantoin is also known as (2,5-dioxo-4-imidazolidinyl) urea and has the chemical formula C₄H₆N₄O₃. Allantoin has been found to reduce and inhibit formaldehyde emissions according to the present disclosure more effectively than many formaldehyde scavengers used in the past. Allantoin has also been found to reduce formaldehyde emissions even when one or more light stabilizers are present in the composition.

The amount of the emission control agent present in the polymer composition can depend upon various factors including the light stabilizer present and the desired results. In general, the emission control agent is present in the polymer composition in an amount greater than about 0.01% by weight, such as in an amount greater than about 0.05% by weight, such as in an amount greater than about 0.1% by weight. In general, the emission control agent is present in an amount less than about 5% by weight, such as in an amount less than 2% by weight, such as in an amount less than about 1% by weight.

Light stabilizers that may be present in the composition include sterically hindered amines. Such compounds include 2,2,6,6-tetramethyl-4-piperidyl compounds, e.g., bis(2,2,6,6-tetramethyl-4-piperidyl) sebacate (Tinuvin 770, BASF) or the polymer of dimethyl succinate and 1-(2-hydroxyethyl)-4-hydroxy-2,2,6,6-tetramethyl-4-piperidine (Tinuvin 622. BASF). In one embodiment, the light stabilizer may comprise 2-(2H-benzzotriazol-2-yl) 4,6-bis(1-ethyl-1-phenyl-ethyl)phenol (Tinuvin 234). Other hindered amine light stabilizers that may be used include oligomeric compounds that are N-methylated. For instance, another example of a hindered amine light stabilizer comprises ADK STAB LA-63 light stabilizer available from Adeka Palmarole.

One or more light stabilizers may be present in the composition in an amount generally less than about 5% by weight, such as in an amount less than 4% by weight, such as in an amount less than about 2% by weight. The light stabilizers, when present, can be included in amounts greater than about 0.1% by weight, such as in amounts greater than about 0.5% by weight.

In one embodiment, the hindered amine light stabilizer may have a substantially neutral pH. For instance, the pH of the light stabilizer may be from about 5 to about 9, such as from about 6 to about 8. In one particular embodiment, the pH of the hindered amine can be from about 6.5 to about 7.5.

In one particular embodiment, the hindered amine may comprise an oligomeric N-methylated hindered amine. For instance, in one particular embodiment, the hindered amine may comprise a mixed 1,2,2,6,6-pentamethyl-4-piperidinolitetramethyl ester of 1,2,3,4-butanetetracarboxylic acid. For instance, the hindered amine may comprise a mixture of 1,2,3,4-butanetetracarboxylic acid, tetramethyl ester, 1,2,2,6,6-pentamethyl-4-piperidinol and B,B,B′,B′-tetramethyl-2,4,8,10-tetraoxaspiro[5,5]undecane-3,9-diethanol.

In addition to the above components, the polymeric composition may contain various other additives and ingredients, For instance, the composition may contain colorants, antioxidants, heat stabilizers, processing aids, and fillers.

Colorants that may be used include any desired inorganic pigments, such as titanium dioxide, ultramarine blue, cobalt blue, and other organic pigments and dyes, such as phthalocyanines, anthraquinones, and the like. Other colorants include carbon black or various other polymer-soluble dyes. The colorants can generally be present in the composition in an amount up to about 10 percent by weight.

In one embodiment, the composition may contain a nucleant. The nucleant, for instance, may increase crystallinity and may comprise an oxymethylene terpolymer. In one particular embodiment, for instance, the nucelant may comprise a terpolymer of butanediol diglycidyl ether, ethylene oxide, and trioxane. The nucleant can be present in the composition in an amount greater than about 0.05% by weight, such as greater than about 0.1% by weight. The nucleant may also be present in the composition in an amount less than about 2% by weight, such as in an amount less than about 1% by weight.

Still another additive that may be present in the composition is a sterically hindered phenol compound, which may serve as an antioxidant. Examples of such compounds, which are available commercially, are pentaerythrityl tetrakis[3-(3,5-di-tert-butyl-4-hydroxyphenyl)propionate] (Irganox 1010, BASF), triethylene glycol bis[3-(3-tert-butyl-4-hydroxy-5-methylphenyl)propionate] (Irganox 245, BASF), 3,3′-bis[3-(3,5-di-tert-butyl-4-hydroxyphenyl)propionohydrazide] (Irganox MD 1024, BASF), hexamethylene glycol bis[3-(3,5-di-tert-butyl-4-hydroxyphenyl)propionate] (Irganox 259, BASF), and 3,5-di-tert-butyl-4-hydroxytoluene (Lowinox BHT, Chemtura). Preference is given to Irganox 1010 and especially Irganox 245. The above compounds may be present in the composition in an amount less than about 2% by weight, such as in an amount from about 0.01% to about 1% by weight.

Fillers that may be included in the composition include glass beads, wollastonite, loam, molybdenum disulfide or graphite, inorganic or organic fibers such as glass fibers, carbon fibers or aramid fibers. The glass fibers, for instance, may have a length of greater than about 3 mm, such as from 5 to about 50 mm. The composition can further include thermoplastic or thermoset polymeric additives, or elastomers such as polyethylene, polyurethane, polymethyl methacrylate, polybutadiene, polystyrene, or else graft copolymers whose core has been prepared by polymerizing 1,3-butadiene, isoprene, n-butyl acrylate, ethylhexyl acrylate, or mixtures of these, and whose shell has been prepared by polymerizing styrene, acrylonitrile or (meth)acrylates.

In one embodiment, the composition may also contain one or more lubricants. The lubricant may comprise a polymer wax composition. Lubricants that may be included in the composition include, for instance, n,n′-ethylene bisstearamide. In one embodiment, a polyethylene glycol polymer may be present in the composition. The polyethylene glycol, for instance, may have a molecular weight of from about 1000 to about 5000, such as from about 3000 to about 4000. In one embodiment, for instance, PEG-75 may be present.

The polymer composition of the present disclosure can be used to produce various molded parts. The parts can be formed through any suitable molding process, such as an injection molding process or through a blow molding process. Polymer articles that may be made in accordance with the present disclosure include knobs, door handles, automotive interior panels, and the like without limitation.

The present disclosure may be better understood with reference to the following example.

### EXAMPLE

The following example was conducted in order to demonstrate some of the advantages and benefits of polymer compositions made according to the present disclosure.

Various polymer compositions were formulated, molded into test specimens, and tested for formaldehyde emission and/or color difference values after exposure to ultraviolet light. The polymer compositions contained an oxymethylene copolymer comprising —OCH₃ terminal groups and from about 10% to about 20% of hydroxyethylene terminal groups. The polyoxymethylene polymer had a melt volume rate of about 1.6 cm³/10 min according to ISO Test 1133. The polyoxymethylene polymer has a tensile stress at yield (50 mm/min) according to ISO Test 527-2/1A of from about 69 MPa to about 80 MPa, had a tensile strain at yield of from about 20% to about 40%, and particularly from about 23% to about 28%, and had a tensile modulus (1 mm/min) of greater than 3000 MPa, such as from 3000 MPa to about 3500 MPa. The polyoxymethylene polymer had a flexural modulus at 23° C. according to ISO Test 178 of greater than 2500 MPa, such as from about 2600 MPa to about 3000 MPa. The polyoxymethylene polymer had a Charpy notched impact strength at 23° C. according to ISO Test 179/1eA of greater than 12 kJ/m², such as from about 13 kJ/m² to about 20 kJ/m² and had a Charpy notched impact strength at −30° C. of greater than about 10 kJ/m², such as from about 10 kJ/m² to about 15 kJ/m². The polyoxymethylene polymer had a melting temperature according to ISO Test 11357-1, -2, -3 of greater than about 175° C., such as about 176° C. and had a DTUL at 1.8 MPa according to ISO Test 75-1/-2 of from about 97° C. to about 110° C., such as about 102° C.

A color masterbatch was produced with the above polyoxymethylene polymer. The color masterbatch was blended in a high intensity mixer for one minute and included the following formulation:

| | Amount |
|---|---|
| Ingredient | (weight percentage) |
| Polyoxymethylene polymer | 91.352 |
| Pigment White 6 | 1.3 |
| Pigment Red 254 | 4.9 |
| Pigment Yellow 110 | 2.44 |
| Pigment Black 7 | 0.008 |

The above masterbatch produced molded articles having a red color.

The above polymer masterbatch was blended with further amounts of polyoxymethylene polymer and various additives. The samples were oreblended, extruded on a single-screw extruder and molded into plagues for UV testing and formaldehyde emission testing. Formaldehyde emission testing was conducted according to Test VDA 275, while UV testing was performed according to the Volkswagen Interior Automotive Standard PV1303 for a total exposure of ten cycles at 2800 kJ/m². Color difference after exposure was determined and reported as DEcmc using a l:c ratio of 1.3:1.

The first formulations tested are as follows:

TABLE 1

| | Sample | Sample |
|---|---|---|
| Ingredient | No. 1 | No. 2 |
| Polyoxymethylene Polymer | 89.65 | 88.16 |
| Color masterbatch | 9.09 | 9.09 |
| Nucleant | | 0.50 |
| PEG-75 (average molecular weight 3350) | 0.50 | 0.50 |
| 2-(2H-benzzotriazol-2-yl)4,6-bis(1-ethyl-1-phenyl- | 0.30 | 0.40 |
| ethyl)phenol | | |
| bis(2,2,6,6-tetramethyl-4-piperidyl)sebacate | 0.30 | |
| Calcium propionate | 0.10 | |
| Melamine | 0.03 | |
| Pentaerythrityl tetrakis [3-(3,5-di-tert-butyl-4- | 0.03 | 0.10 |
| hydroxyphenyl)propionate] | | |
| Benzoguanamine | | 0.50 |
| 1,2,3,4-butanetetracarboxylic acid, tetramethyl | | 0.50 |
| ester, reaction products with 1,2,2,6,6- | | |
| pentamethyl-4-piperidinol and B,B,B′,B′- | | |
| tetramethyl-2,4,8,10-tetraoxaspiro[5,5]undecane- | | |
| 3,9-diethanol | | |
| N,N′ethylene bisstearamide | | 0.20 |
| Tricalcium Citrate | | 0.05 |
| Formaldehyde emission (ppm) | 143.2 | 136.4 |
| DEcmc | 1.03 | 0.77 |

As shown above, ultraviolet light stability for Sample No. 1 and Sample No. 2 were very good. However, even though ultraviolet light stability was displayed by the samples, the samples had relatively high formaldehyde emission even when containing benzoguanamine or a melamine. The above formaldehyde emission characteristics are particularly problematic when formulating polymer compositions containing high strength polyoxymethylenes, such as the oxymethylene copolymer used.

In the following samples, an emission control agent comprising allantoin was used. The presence of allantoin significantly and unexpectedly decreased formaldehyde emissions in relation to the use of a melamine or benzoguanamine. The following samples were formulated and tested.

TABLE 2

| | Sam- | Sam- | Sam- | Sam- | Sam- |
|---|---|---|---|---|---|
| | ple | ple | ple | ple | ple |
| | No. 3 | No. 4 | No. 5 | No. 6 | No. 7 |
| Polyoxymethylene Polymer | 89.63 | 89.63 | 89.63 | 89.63 | 89.63 |
| Color masterbatch | 9.09 | 9.09 | 9.09 | 9.09 | 9.09 |
| 2-(2H-benzzotriazol-2-yl)4,6- | 0.30 | 0.30 | 0.30 | 0.30 | 0.30 |
| bis(1-ethyl-1-phenyl- | | | | | |
| ethyl)phenol | | | | | |
| PEG-75 (average molecular | 0.50 | 0.50 | 0.50 | 0.50 | 0.50 |
| weight 3350) | | | | | |
| Pentaerythrityl tetrakis [3-(3,5- | 0.03 | 0.03 | 0.03 | 0.03 | 0.03 |
| di-tert-butyl-4- | | | | | |
| hydroxyphenyl)propionate] | | | | | |
| Tricalcium Citrate | 0.05 | 0.05 | 0.05 | 0.05 | 0.05 |
| Allantoin | 0.10 | 0.10 | 0.10 | 0.10 | 0.10 |
| Thermoplastic copolyamide | 0.05 | | | | |
| bis(2,2,6,6-tetramethyl-4- | 0.30 | | | | |
| piperidyl)sebacate (pH | | | | | |
| unknown) | | | | | |
| 1,2,3,4-butanetetracarboxylic | | 0.30 | | | |
| acid, tetramethyl ester, | | | | | |
| reaction products with | | | | | |
| 1,2,2,6,6-pentamethyl-4- | | | | | |
| piperidinol and B,B,B′,B′- | | | | | |
| tetramethyl-2,4,8,10- | | | | | |
| tetraoxaspiro[5,5]undecane- | | | | | |
| 3,9-diethanol (pH unknown) | | | | | |
| Polymer of 2,2,4,4-tetramethyl- | | | 0.30 | | |
| 7-oxa-3,20-diaza- | | | | | |
| dispiro[5.1.11.2]-heneicosan- | | | | | |
| 21-on and epichlorohydrin | | | | | |
| (pH = 6.7) | | | | | |
| N,N′-bis(2,2,6,6-tetramethyl-4- | | | | 0.30 | |
| piperidyl)-N,N′- | | | | | |
| diformylhexamethylenediamine | | | | | |
| (pH = 11) | | | | | |
| Sterically hindered amine | | | | | 0.30 |
| oligomer having CAS No. | | | | | |
| 152261-33-1 | | | | | |
| (pH = 7.5) | | | | | |
| Formaldehyde emission (ppm) | 63.65 | 12.01 | 25.64 | 44.11 | 19.47 |

As shown above, the type of light stabilizer used in conjunction with the emission control agent appeared to have a substantial effect on formaldehyde emission.

As shown above, Sample No. 4 produced the lowest formaldehyde emission. In the following formulations, the amount of the light stabilizer in relation to the amount of the emission control agent were varied. The following results were obtained:

TABLE 3

| | Sample | Sample | Sample | Sample | Sample | Sample | Sample |
|---|---|---|---|---|---|---|---|
| Ingredient | No. 8 | No. 9 | No. 10 | No. 11 | No. 12 | No. 13 | No. 14 |
| Polyoxymethylene Polymer | 89.66 | 89.61 | 89.59 | 89.56 | 89.61 | 89.71 | 89.81 |
| Color Masterbatch | 9.09 | 9.09 | 9.09 | 9.09 | 9.09 | 9.09 | 9.09 |
| 2-(2H-benzzotriazol-2- | 0.30 | 0.30 | 0.30 | 0.30 | 0.30 | 0.30 | 0.30 |
| yl)4,6-bis(1-ethyl-1-phenyl- | | | | | | | |
| ethyl)phenol | | | | | | | |
| 1,2,3,4- | 0.25 | 0.25 | 0.25 | 0.25 | 0.20 | 0.10 | 0.00 |
| butanetetracarboxylic acid, | | | | | | | |
| tetramethyl ester, reaction | | | | | | | |
| products with 1,2,2,6,6- | | | | | | | |
| pentamethyl-4-piperidinol | | | | | | | |
| and B,B,B′,B′-tetramethyl- | | | | | | | |
| 2,4,8,10- | | | | | | | |
| tetraoxaspiro[5,5]undecane- | | | | | | | |
| 3,9-diethanol (ph unknown) | | | | | | | |
| PEG-75 (average molecular | 0.50 | 0.50 | 0.50 | 0.50 | 0.50 | 0.50 | 0.50 |
| weight 3350) | | | | | | | |
| Pentaerythrityl tetrakis [3- | 0.10 | 0.10 | 0.10 | 0.10 | 0.10 | 0.10 | 0.10 |
| (3,5-di-tert-butyl-4- | | | | | | | |
| hydroxyphenyl)propionate] | | | | | | | |
| Tricalcium Citrate | 0.10 | 0.10 | 0.10 | 0.10 | 0.10 | 0.10 | 0.10 |
| Allantoin | 0.00 | 0.05 | 0.07 | 0.10 | 0.10 | 0.10 | 0.10 |
| Formaldehyde emission | 69.43 | 24.29 | 18.26 | 7.58 | 6.16 | 6.90 | 6.90 |
| (ppm) | | | | | | | |
| DEcmc | 0.30 | 0.38 | 0.35 | 0.30 | 0.38 | 0.35 | 5.97 |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A molded product having resistance to ultraviolet light and low formaldehyde emission comprising:
a molded article made from a polymer composition, the polymer composition comprising:
an emission control agent comprising allantoin;
at least one light stabilizer; and
an oxymethylene copolymer containing oxymethylene units and comonomers units, the proportion of comonomers units based on the proportion of oxymethylene units being between about 0.001% by weight and about 1% by weight; wherein the emission control agent and the at least one light stabilizer are present in the polymer composition in an amount such that the polymer composition exhibits a formaldehyde emission pursuant to VDA 275 of less than about 15 ppm and exhibits a color difference value (DEcmc) of less than about 5 after exposure to ten cycles of 280 kJ/m² irradiation in a xenon arc weatherometer operated according to Volkswagen Test PV1303.

2. A molded product as defined in claim 1, wherein the oxymethylene copolymer comprises oxymethylene units and oxyalkylene units having at least two carbon atoms and a proportion of terminal alkyl ether groups and of terminal hydroxyalkylene groups having at least two carbon atoms, the proportion of terminal alkyl ether groups, based on all terminal groups, being at least 80% and the proportion of terminal hydroxyalkylene groups having at least two carbon atoms, based on all terminal groups, being up to 20%.

3. A molded product as defined in claim 1, wherein the oxymethylene copolymer has a melt flow rate at 190° C. and at a load of 2.16 kg of from about 0.5 g/10 min to about 3 g/10 min.

4. A molded product as defined in claim 1, wherein the ultraviolet light stabilizer comprises a hindered amine.

5. A molded product as defined in claim 4, wherein the hindered amine has a pH of between about 6 and about 8.

6. A molded product as defined in claim 4, wherein the hindered amine comprises 1,2,3,4-butanetetracarboxylic acid.

7. A molded product as defined in claim 1, wherein the polymer composition further contains at least one coloring agent.

8. A molded product as defined in claim 5, wherein the at least one coloring agent is present in the composition such that the molded article has non-neutral color.

9. A molded product as defined in claim 4, wherein the emission control agent is present in the polymer composition in an amount from about 0.01% to about 5% by weight and wherein the light stabilizer is present in the polymer composition in an amount from about 0.1% to about 2% by weight.

10. A molded product as defined in claim 9, wherein the polymer composition exhibits a formaldehyde emission pursuant to VDA 275 of less than about 10 ppm.

11. A molded product as defined in claim 9, wherein the polymer composition contains at least one coloring agent and exhibits a color difference value (DEcmc) of less than about 2 after exposure to 10 cycles of 280 kJ/m² irradiation in a xenon arc weatherometer operated according to Volkswagen Test PV1303.

12. A molded product as defined in claim 9, wherein the polymer composition contains at least one coloring agent and exhibits a color different value (DEcmc) of less than about 1 after exposure to 10 cycles of 280 kJ/m² irradiation in a xenon arc weatherometer operated according to Volkswagen Test PV1303.

13. A molded product as defined in claim 1, wherein the oxymethylene copolymer is present in the polymer composition in an amount from about 60% to about 98% by weight.

14. A molded product as defined in claim 2, wherein at least about 90% of all of the terminal groups of the oxymethylene copolymer are terminal alkyl ether groups.

15. A molded product as defined in claim 2, wherein the proportion of oxyalkylene units, based upon the proportion of oxymethylene units is between about 0.001 mol % and about 0.7 mol %.

16. A molded product as defined in claim 1, wherein the oxymethylene copolymer has the formula:
—(O—CH₂)ₓ—(O—CₘH₂ₘ)_{y}—
and has terminal alkyl ether groups of the formula —O—R¹ and terminal hydroxyalkylene groups of the formula —O—CₘH₂ₘ—OH and, if appropriate, terminal groups of the formula —O—R²,
x is a positive integer, preferably from 10 to 10 000,
m is an integer from 2 to 6,
y is an integer from 0 to 10,
the ratio yₐᵣ/xₐᵣ is from 0.001 to 0.7
yₐᵣ being the arithmetic mean of all values y in the polymer mixture and
xₐᵣ being the arithmetic mean of all values x in the polymer mixture,
R¹ is a linear or branched alkyl group and
R² is a formyl group —CHO, with the proviso that the proportion of the terminal alkyl ether groups of the formula —O—R¹, based on all terminal groups, is at least 80%, and that the proportion of the terminal hydroxyalkylene groups of the formula —O—CₘH₂ₘ—OH, based on all terminal groups, is up to 20%.

17. A polymer composition comprising:
an oxymethylene copolymer comprising oxymethylene units and oxyalkylene units having at least two carbon atoms and a proportion of terminal alkyl ether groups and of terminal hydroxyalkylene groups having at least two carbon atoms, the proportion of terminal alkyl ether groups, based on all terminal groups, being at least 80% and the proportion of terminal hydroxyalkylene groups having at least two carbon atoms, based on all terminal groups, being up to 20%, the oxymethylene copolymer being present in the polymer composition in an amount from about 60% to about 98% by weight;
an emission control agent comprising allantoin being present in the polymer composition in an amount from about 0.01% to about 5% by weight;
at least one light stabilizer, wherein the light stabilizer comprises a hindered amine, the hindered amine having a pH of from about 6 to about 8, the hindered amine being present in the polymer composition in an amount from about 0.1% to about 2% by weight;
at least one coloring agent; and
wherein the emission control agent and the at least one light stabilizer are present in the polymer composition in an amount such that the polymer composition exhibits a formaldehyde emission pursuant to VDA 275 of less than about 15 ppm and exhibits a color difference value (DEcmc) of less than about 5 after exposure to ten cycles of 280 kJ/m² irradiation in a xenon arc weatherometer operated according to Volkswagen test PV1303.

18. A polymer composition as defined in claim 17, wherein at least about 90% of all of the terminal groups of the oxymethylene copolymer are terminal alkyl ether groups.

19. A polymer composition as defined in claim 17, wherein the proportion of oxyalkylene units, based upon the proportion of oxymethylene units is between about 0.001 mol percent and about 0.7 mol percent.
